(19) United States
(12) Patent Application Publication
(10) Pub. No.: US 2023/0119935 A1
(43) Pub. Date: Apr. 20, 2023

(54) GAZE-GUIDED IMAGE CAPTURE

(71) Applicant: Meta Platforms Technologies, LLC, Menlo Park, CA (US)

(72) Inventors: Sebastian Sztuk, Menlo Park, CA (US); Salvael Ortega Estrada, Redmond, WA (US)

(21) Appl. No.: 17/504,396

(22) Filed: Oct. 18, 2021

(51) Int. Cl. G02B 27/01

(52) U.S. Cl. CPC G02B 27/0172; G02B 2027/0178; G02B 2027/0187; G02B 2027/014; G02B 2027/0138; G02B 2027/0123

(57) ABSTRACT

A gaze direction of an eye or eyes of a user of a head mounted device is determined. One or more images is captured with a camera of a head mounted device. Gaze-guided images are generated from the one or more images based on the gaze direction of the user.

### TECHNICAL FIELD

This disclosure relates generally to cameras, and in particular to capturing gaze-guided images.

### BACKGROUND INFORMATION

A head mounted device is a wearable electronic device, typically worn on the head of a user. Head mounted devices may include one or more electronic components for use in a variety of applications, such as gaming, aviation, engineering, medicine, entertainment, activity tracking, and so on. Head mounted devices may include one or more displays to present virtual images to a wearer of the head mounted device. When a head mounted device includes a display, it may be referred to as a head mounted display. Head mounted devices may include one or more cameras to facilitate capturing images.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates an example head mounted device for capturing gaze-guided images, in accordance with implementations of the disclosure.

FIG. 2A illustrates an example gaze-guided image system, in accordance with implementations of the disclosure.

FIG. 2B illustrates a top view of a head mounted device being worn by a user, in accordance with implementations of the disclosure.

FIG. 2C illustrates an example scene of an external environment of a head mounted device, in accordance with implementations of the disclosure.

FIGS. 3A-3C illustrate eye positions of an eye associated with gaze vectors, in accordance with implementations of the disclosure.

FIG. 4 illustrates a top view of a portion of an example head mounted device, in accordance with implementations of the disclosure.

FIG. 5 illustrates a flow chart illustrating an example process of generating gaze-guided images with a head mounted device, in accordance with implementations of the disclosure.

FIG. 6 illustrates an example cropped image that may be used as a gaze-guided image, in accordance with implementations of the disclosure.

FIG. 7 illustrates an example zoomed image that may be used as a gaze-guided image, in accordance with implementations of the disclosure.

FIG. 8 illustrates an example camera that includes a lens assembly configured to focus image light onto an image sensor, in accordance with implementations of the disclosure.

FIG. 9 illustrates an example camera that includes a lens assembly having an auto-focus module configured to focus image light onto an image sensor, in accordance with implementations of the disclosure.

FIG. 10 illustrates an example camera that can be rotated, in accordance with implementations of the disclosure.

### DETAILED DESCRIPTION

Embodiments of gaze-guided image capturing are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one implementation” or “an implementation” means that a particular feature, structure, or characteristic described in connection with the implementation is included in at least one implementation of the present invention. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

Implementations of devices, systems, and methods of capturing gaze-guided images are disclosed herein. In some implementations of the disclosure, a head mounted device includes an eye-tracking system that determines a gaze direction of an eye of a user of the head mounted device. One or more gaze-guided images is generated based on the gaze direction from one or more images captured by one or more cameras of the head mounted device that are configured to image an external environment of the head mounted device.

In an implementation, a head mounted device includes an eye-tracking system, a first image sensor, a second image sensor, and processing logic. The eye-tracking system generates a gaze direction of an eye of a user of the head mounted device. The processing logic receives the gaze direction and selects between the first image sensor and the second image sensor to capture the gaze-guided image. The image sensor that has a FOV that corresponds to the gaze direction may be selected for capturing the gaze-guided image(s), for example.

An implementation of the disclosure includes a method of operating a head mounted device. A gaze direction of an eye of a user of a head mounted device is determined and one or more images are captured by a camera of the head mounted device. One or more gaze-guided images are generated from the one or more images based on the gaze direction of the user. In an implementation, generating the gaze-guided images includes digitally cropping one or more of the images. In an implementation, generating the gaze-guided images includes rotating the camera in response to the gaze direction.

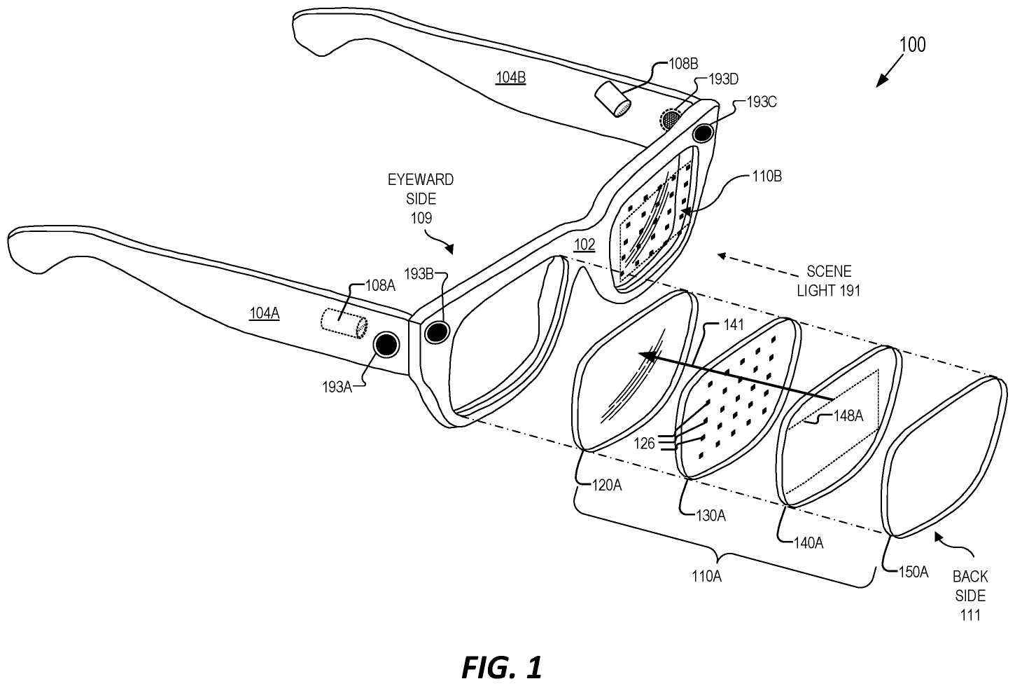

Generating gaze-guided images in response to a gaze direction allows users to capture images that are relevant to where they are gazing/looking without requiring additional effort. Additionally, in some implementations, generating gaze-guided images in response to a gaze direction of the user allows for one or more cameras to capture images that are focused to a depth of field that the user is looking at. By way of example, cameras may be focused to a near-field subject (a flower close to the user) or a far-field subject (e.g. mountains in the distance) in response to the gaze direction determined by the eye-tracking system. These and other implementations are described in more detail in connection with FIGS. 1-10.

FIG. 1 illustrates an example head mounted device 100 for capturing gaze-guided images, in accordance with aspects of the present disclosure. The illustrated example of head mounted device 100 is shown as including a frame 102, temple arms 104A and 104B, and near-eye optical elements 110A and 110B. Cameras 108A and 108B are shown as coupled to temple arms 104A and 104B, respectively. Cameras 108A and 108B may be configured to image an eyebox region to image the eye of the user to capture eye data of the user. Cameras 108A and 108B may be included in an eye-tracking system that is configured to determine a gaze direction of an eye (or eyes) of a user of the head mounted device. Cameras 108A and 108B may image the eyebox region directly or indirectly. For example, optical elements 110A and/or 110B may have an optical combiner (not specifically illustrated) that is configured to redirect light from the eyebox to the cameras 108A and/or 108B. In some implementations, near-infrared light sources (e.g. LEDs or vertical-cavity side emitting lasers) illuminate the eyebox region with near-infrared illumination light and cameras 108A and/or 108B are configured to capture infrared images for eye-tracking purposes. Cameras 108A and/or 108B may include complementary metal-oxide semiconductor (CMOS) image sensor. A near-infrared filter that receives a narrow-band near-infrared wavelength may be placed over the image sensor so it is sensitive to the narrow-band near-infrared wavelength while rejecting visible light and wavelengths outside the narrow-band. The near-infrared light sources (not illustrated) may emit the narrow-band wavelength that is passed by the near-infrared filters.

In addition to image sensors, various other sensors of head mounted device 100 may be configured to capture eye data that is utilized to determine a gaze direction of the eye (or eyes). Ultrasound or light detection and ranging (LIDAR) sensors may be configured in frame 102 to detect a position of an eye of the user by detecting the position of the cornea of the eye, for example. Discrete photodiodes included in frame 102 or optical elements 110A and/or 110B may also be used to detect a position of the eye of the user. Discrete photodiodes may be used to detect “glints” of light reflecting off of the eye, for example. Eye data generated by various sensors may not necessarily be considered “images” of the eye yet the eye-data may be used by an eye-tracking system to determine a gaze direction of the eye(s).

FIG. 1 also illustrates an exploded view of an example of near-eye optical element 110A. Near-eye optical element 110A is shown as including an optically transparent layer 120A, an illumination layer 130A, a display layer 140A, and a transparency modulator layer 150A. Display layer 140A may include a waveguide 148 that is configured to direct virtual images included in visible image light 141 to an eye of a user of head mounted device 100 that is in an eyebox region of head mounted device 100. In some implementations, at least a portion of the electronic display of display layer 140A is included in the frame 102 of head mounted device 100. The electronic display may include an LCD, an organic light emitting diode (OLED) display, micro-LED display, pico-projector, or liquid crystal on silicon (LCOS) display for generating the image light 141.

When head mounted device 100 includes a display, it may be considered a head mounted display. Head mounted device 100 may be considered an augmented reality (AR) head mounted display. While FIG. 1 illustrates a head mounted device 100 configured for augmented reality (AR) or mixed reality (MR) contexts, the disclosed implementations may also be used in other implementations of a head mounted display such as virtual reality head mounted displays. Additionally, some implementations of the disclosure may be used in a head mounted device that does not include a display.

Illumination layer 130A is shown as including a plurality of in-field illuminators 126. In-field illuminators 126 are described as “in-field” because they are in a field of view (FOV) of a user of the head mounted device 100. In-field illuminators 126 may be in a same FOV that a user views a display of the head mounted device 100, in an implementation. In-field illuminators 126 may be in a same FOV that a user views an external environment of the head mounted device 100 via scene light 191 propagating through near-eye optical elements 110. Scene light 191 is from the external environment of head mounted device 100. While in-field illuminators 126 may introduce minor occlusions into the near-eye optical element 110A, the in-field illuminators 126, as well as their corresponding electrical routing may be so small as to be unnoticeable or insignificant to a wearer of head mounted device 100. In some implementations, illuminators 126 are not in-field. Rather, illuminators 126 could be out-of-field in some implementations.

As shown in FIG. 1, frame 102 is coupled to temple arms 104A and 104B for securing the head mounted device 100 to the head of a user. Example head mounted device 100 may also include supporting hardware incorporated into the frame 102 and/or temple arms 104A and 104B. The hardware of head mounted device 100 may include any of processing logic, wired and/or wireless data interface for sending and receiving data, graphic processors, and one or more memories for storing data and computer-executable instructions. In one example, head mounted device 100 may be configured to receive wired power and/or may be configured to be powered by one or more batteries. In addition, head mounted device 100 may be configured to receive wired and/or wireless data including video data.

FIG. 1 illustrates near-eye optical elements 110A and 110B that are configured to be mounted to the frame 102. In some examples, near-eye optical elements 110A and 110B may appear transparent or semi-transparent to the user to facilitate augmented reality or mixed reality such that the user can view visible scene light from the environment while also receiving image light 141 directed to their eye(s) by way of display layer 140A. In further examples, some or all of near-eye optical elements 110A and 110B may be incorporated into a virtual reality headset where the transparent nature of the near-eye optical elements 110A and 110B allows the user to view an electronic display (e.g., a liquid crystal display (LCD), an organic light emitting diode (OLED) display, or micro-LED display, etc.) incorporated in the virtual reality headset.

As shown in FIG. 1, illumination layer 130A includes a plurality of in-field illuminators 126. Each in-field illuminator 126 may be disposed on a transparent substrate and may be configured to emit light to an eyebox region on an eyeward side 109 of the near-eye optical element 110A. In some aspects of the disclosure, the in-field illuminators 126 are configured to emit near infrared light (e.g. 750 nm-1.6 μm). Each in-field illuminator 126 may be a micro light emitting diode (micro-LED), an edge emitting LED, a vertical cavity surface emitting laser (VCSEL) diode, or a Superluminescent diode (SLED).

Optically transparent layer 120A is shown as being disposed between the illumination layer 130A and the eyeward side 109 of the near-eye optical element 110A. The optically transparent layer 120A may receive the infrared illumination light emitted by the illumination layer 130A and pass the infrared illumination light to illuminate the eye of the user in an eyebox region of the head mounted device. As mentioned above, the optically transparent layer 120A may also be transparent to visible light, such as scene light 191 received from the environment and/or image light 141 received from the display layer 140A. In some examples, the optically transparent layer 120A has a curvature for focusing light (e.g., display light and/or scene light) to the eye of the user. Thus, the optically transparent layer 120A may, in some examples, may be referred to as a lens. In some aspects, the optically transparent layer 120A has a thickness and/or curvature that corresponds to the specifications of a user. In other words, the optically transparent layer 120A may be a prescription lens. However, in other examples, the optically transparent layer 120A may be a non-prescription lens.

Head mounted device 100 includes at least one camera for generating gaze-guided images in response to a gaze direction of the eye(s). In the particular illustrated example of FIG. 1, head mounted device includes four cameras 193A, 193B, 193C, and 193D. Cameras 193A, 193B, 193C, and/or 193D may include a lens assembly configured to focus image light onto a complementary metal-oxide semiconductor (CMOS) image sensor. The lens assemblies may include optical zoom and auto-focus features. In the illustrated implementation, camera 193A is configured to image the external environment to the right of head mounted device 100 and camera 193D is configured to image the external environment to the left of head mounted device 100. Camera 193B is disposed in the upper-right corner of frame 102 and configured to image the forward-right external environment of head mounted device 100. Camera 193C is disposed in the upper-left corner of frame 102 and configured to image the forward-left external environment of head mounted device 100. The field of view (FOV) of camera 193B may overlap a FOV of camera 193C.

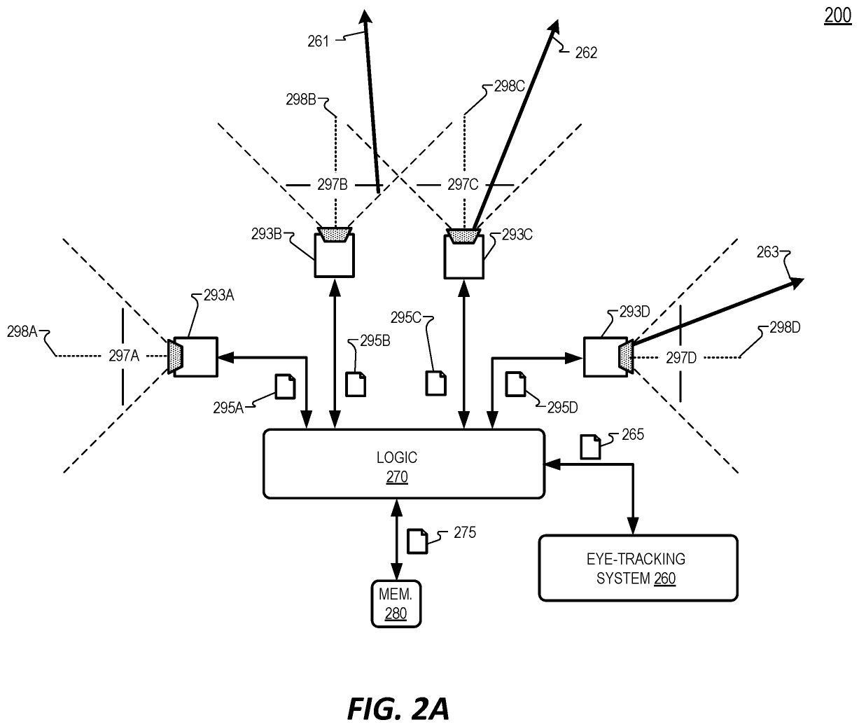

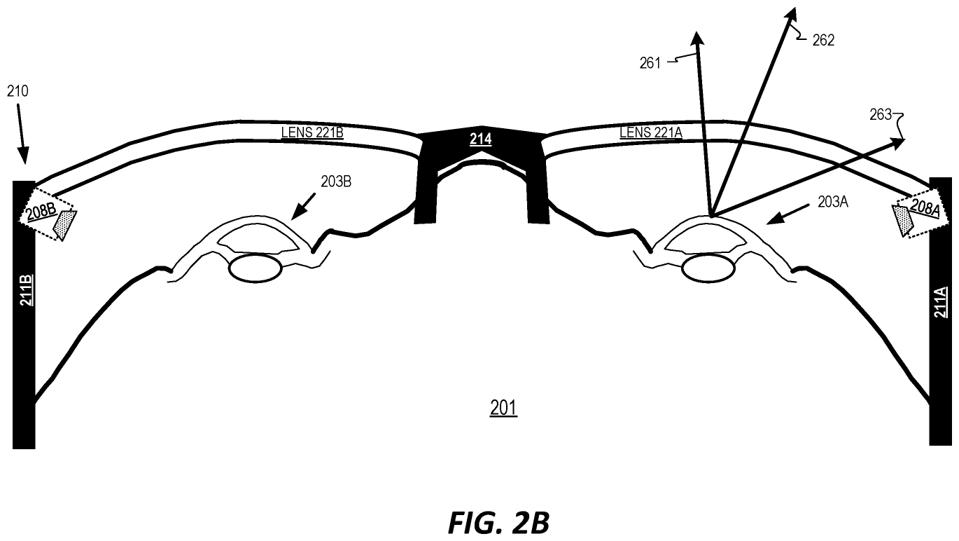

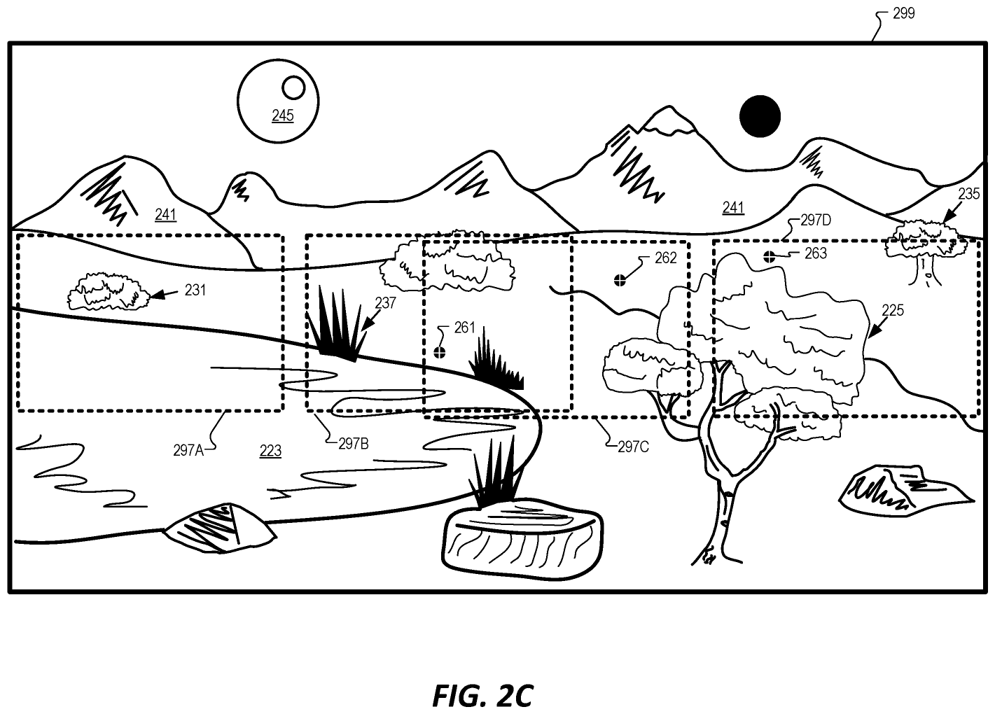

FIG. 2A illustrates an example gaze-guided image system 200, in accordance with implementations of the disclosure. Gaze-guided image system 200 may be included in a head mounted device such as head mounted device 100. Gaze-guided image system 200 includes processing logic 270, memory 280, eye-tracking system 260, and cameras 293A, 293B, 293C, and 293D (collectively referred to as cameras 293). Cameras 293 may be used as cameras 193A-193D and may include similar features as described with respect to cameras 193A-193D. Each camera 293 may include a lens assembly configured to focus image light onto an image sensor. While system 200 illustrates four cameras, other systems may include any integer n number of cameras in a plurality of cameras.

In FIG. 2A, first camera 293A includes a first image sensor configured to capture first images 295A of an external environment of a head mounted device. The first image sensor has a first field of view (FOV) 297A and axis 298A illustrates a middle of the first FOV 297A. Axis 298A may correspond to an optical axis of a lens assembly of first camera 293A and axis 298A may intersect a middle of the first image sensor. First camera 293A is configured to provide first images 295A to processing logic 270.

Second camera 293B includes a second image sensor configured to capture second images 295B of an external environment of the head mounted device. The second image sensor has a second field of FOV 297B and axis 298B illustrates a middle of the second FOV 297B. Axis 298B may correspond to an optical axis of a lens assembly of second camera 293B and axis 298B may intersect a middle of the second image sensor. Second camera 293B is configured to provide second images 295B to processing logic 270.

Third camera 293C includes a third image sensor configured to capture third images 295C of an external environment of the head mounted device. The third image sensor has a third field of FOV 297C and axis 298C illustrates a middle of the third FOV 297C. Axis 298C may correspond to an optical axis of a lens assembly of third camera 293C and axis 298C may intersect a middle of the third image sensor. Third camera 293C is configured to provide third images 295C to processing logic 270.

Fourth camera 293D includes a fourth image sensor configured to capture fourth images 295D of an external environment of the head mounted device. The fourth image sensor has a fourth field of FOV 297D and axis 298D illustrates a middle of the fourth FOV 297D. Axis 298D may correspond to an optical axis of a lens assembly of fourth camera 293D and axis 298D may intersect a middle of the fourth image sensor. Fourth camera 293D is configured to provide fourth images 295D to processing logic 270.

Eye-tracking system 260 includes one or more sensors configured to determine a gaze direction of an eye in an eyebox region of a head mounted device. Eye-tracking system 260 may also include digital or analog processing logic to assist in determining/calculating the gaze direction of the eye. Any suitable technique may be used to determine a gaze direction of the eye(s). For example, eye-tracking system 260 may include one or more cameras to image the eye(s) to determine a pupil-position of the eye(s) to determine where the eye is gazing. In another example, “glints” reflecting off the cornea (and/or other portions of the eye) are utilized to determine the position of the eye that is then used to determine the gaze direction. Other sensors described in association with FIG. 1 may be used in eye-tracking system 260 such as ultrasound sensors, LIDAR sensors, and/or discrete photodiodes to detect a position of an eye to determine the gaze direction.

Eye-tracking system 260 is configured to generate gaze direction data 265 that includes a gaze direction of the eye(s) and provide gaze direction data 265 to processing logic 270. Gaze direction data 265 may include vergence data representative of a focus distance and a direction of where two eyes are focusing. Processing logic 270 is configured to receive gaze direction data 265 from eye-tracking system 260 and select a selected image sensor to capture one or more gaze-guided images based on gaze direction data 265. In the illustrated implementations of FIG. 2A, processing logic 270 generates gaze-guided image(s) 275 and store gaze-guided image(s) 275 to memory 280. In some implementations, memory 280 is included in processing logic 270. A plurality of gaze-guided images may be considered gaze-guided video, in implementations of the disclosure.

In an implementation, processing logic 270 selects a particular image sensor for capturing the gaze-guided image(s) based on the gaze direction included in gaze direction data 265. For example, processing logic 270 may select between two or more image sensors to capture the gaze-guided image(s). Selecting the selected image sensor to capture the one or more gaze-guided images may be based on the gaze direction (included in gaze direction data 265) with respect to the FOV of the image sensors.

The FOV of the image sensors may overlap in some implementations. In FIG. 2A, FOV 297B overlaps with FOV 297C although FOV 297D does not overlap with FOV 297C nor does FOV 297A overlap with FOV 297B, in the illustrated implementations.

FIG. 2A shows gaze vector 263 illustrating a gaze direction determined by eye-tracking system 260. Since gaze vector 263 is within the FOV 297D of the image sensor of camera 293D, processing logic 270 may select the image sensor of camera 293D to capture the gaze-guided image(s). Selecting camera 293D to capture the gaze-guided images may include deselecting the other cameras in the system (in the illustrated example, cameras 293A, 293B, and 293C) so that they are not capturing images or not providing images to processing logic 270. In this context, fourth images 295D captured by camera 293D are stored in memory 280 as gaze-guided images 275.

At a subsequent point in time, a gaze direction of the user may change such that gaze vector 262 is representative of a subsequent gaze direction of subsequent gaze direction data 265. Gaze vector 262 may be included in both FOV 297B and FOV 297C. Processing logic 270 may select the image sensor of the camera where the gaze vector (e.g. gaze vector 262) is closest to a middle of the FOV of that image sensor. In the illustrated example, the image sensor of camera 293C may be selected by processing logic 270 as the “subsequent-selected image sensor” to capture gaze-guided images since gaze vector 262 is closer to the middle of FOV 297C (axis 298C) than it is to the middle of FOV 297B (axis 298B). The subsequent-selected image sensor may then generate the gaze-guided images.

At yet another point in time, a gaze direction of the user may change such that gaze vector 261 is representative of the gaze direction of gaze direction data 265. Gaze vector 261 may be included in both FOV 297B and FOV 297C. Processing logic 270 may select the image sensor of the camera where the gaze vector (e.g. gaze vector 261) is closest to a middle of the FOV of that image sensor. In the illustrated example, the image sensor of camera 293B may be selected by processing logic 270 as the “selected image sensor” to capture gaze-guided images since gaze vector 261 is closer to the middle of FOV 297B (axis 298B) than it is to the middle of FOV 297C (axis 298C). In this context, second images 295B captured by camera 293B are stored in memory 280 as gaze-guided images 275.

FIG. 2B illustrates a top view of a head mounted device 210 being worn by a user 201. The head mounted device 210 includes arms 211A and 211B and nose-piece 214 securing lenses 221A and 22B. Cameras 208A and 208B may be included in an eye-tracking system (e.g. system 260) to generate a gaze direction of eye 203A and/or 203B of user 201 when eye 203A and 203B occupy an eyebox region of head mounted device 210. FIG. 2B illustrates the gaze vectors 261, 262, and 263 of FIG. 2A with respect to a forward-looking resting position of eye 203A. Gaze vectors 261, 262, and 263 may also be generated with respect to both eye 203A and 203B, in some implementations, where the gaze vectors originate from a midpoint between eyes 203A and 203B.

FIG. 2C illustrates an example scene of an external environment of a head mounted device. Scene 299 includes a moon 245, mountains 241, a bush 231, a lake 223, and trees 225 and 235. FIG. 2C illustrates example FOVs 297A, 297B, 297C, and 297D with respect to scene 299. Of course, the illustrated FOVs are merely examples and the FOVs can be rearranged to lap or overlap by moving the orientation of a camera or widening or narrowing the FOV by adjusting a lens assembly of the camera. In the example of FIG. 2C, the gaze guided image(s) generated by system 200 may include the portion of scene 299 that is within FOV 297D since gaze vector 263 (going into the page) is within FOV 297D and therefore the image sensor of camera 293D may be selected as the “selected image sensor.” In this context, fourth images 295D captured by camera 293D would be the gaze-guided images 275. Similarly, gaze guided image(s) generated by system 200 may include the portion of scene 299 that is within FOV 297C since gaze vector 262 (going into the page) is closest to a middle of FOV 297C and therefore the image sensor of camera 293C may be selected as the “selected image sensor.” In this context, third images 295C captured by camera 293C would be the gaze-guided images 275. And, gaze guided image(s) generated by system 200 may include the portion of scene 299 that is within FOV 297B since gaze vector 261 (going into the page) is closest to a middle of FOV 297B and therefore the image sensor of camera 293B may be selected as the “selected image sensor.” In this context, second images 295B captured by camera 293B would be the gaze-guided images 275.

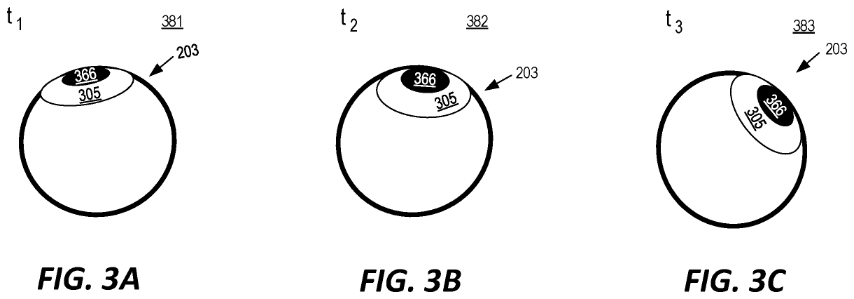

FIGS. 3A-3C illustrate eye positions of eye 203 associated with gaze vectors, in accordance with implementations of the disclosure. At time t₁ 381, eye 203 may be positioned as shown in FIG. 3A. The position of eye 203 in FIG. 3A may correspond with gaze vector 261, for example. At a different time t₂ 382, eye 203 may be positioned as shown in FIG. 3B. The position of eye 203 in FIG. 3B may correspond with gaze vector 262, for example. And, at time t₃ 383, eye 203 may be positioned as shown in FIG. 3C. The position of eye 203 in FIG. 3C may correspond with gaze vector 263, for example. The positions of eye 203 may be measured/determined by a suitable eye-tracking system. The eye-tracking system may determine the position of eye 203 based on a pupil 366 position of eye 203 or based on the position of a cornea 305 of eye 203, for example.

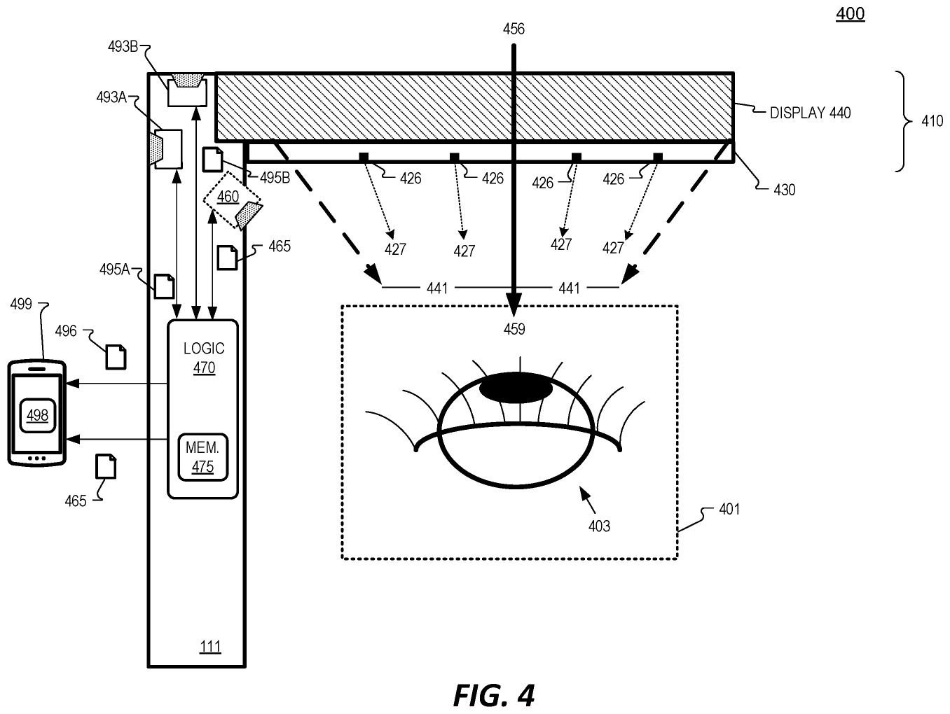

FIG. 4 illustrates a top view of a portion of an example head mounted device 400, in accordance with implementations of the disclosure. Head mounted device 400 may include a near-eye optical element 410 that includes a display layer 440 and an illumination layer 430. Additional optical layers (not specifically illustrated) may also be included in example optical element 410. For example, a focusing lens layer may optionally be included in optical element 410 to focus scene light 456 and/or virtual images included in image light 441 generated by display layer 440.

Display layer 440 presents virtual images in image light 441 to an eyebox region 401 for viewing by an eye 403. Processing logic 470 is configured to drive virtual images onto display layer 440 to present image light 441 to eyebox region 401. Illumination layer 430 includes light sources 426 configured to illuminate an eyebox region 401 with infrared illumination light 427. Illumination layer 430 may include a transparent refractive material that functions as a substrate for light sources 426. Infrared illumination light 427 may be near-infrared illumination light. Eye-tracking system 460 includes a camera configured to image (directly) eye 403, in the illustrated example of FIG. 4. In other implementations, a camera of eye-tracking system 460 may (indirectly) image eye 403 by receiving reflected infrared illumination light from an optical combiner layer (not illustrated) included in optical element 410. The optical combiner layer may be configured to receive reflected infrared illumination light (the infrared illumination light 427 reflected from eyebox region 401) and redirect the reflected infrared illumination light to the camera of eye-tracking system 460. In this implementation, the camera would be oriented to receive the reflected infrared illumination light from the optical combiner layer of optical element 410.

The camera of eye-tracking system 460 may include a complementary metal-oxide semiconductor (CMOS) image sensor, in some implementations. An infrared filter that receives a narrow-band infrared wavelength may be placed over the image sensor of the camera so it is sensitive to the narrow-band infrared wavelength while rejecting visible light and wavelengths outside the narrow-band. Infrared light sources (e.g. light sources 426) such as infrared LEDs or infrared VCSELS that emit the narrow-band wavelength may be oriented to illuminate eye 403 with the narrow-band infrared wavelength.

In the illustrated implementation of FIG. 4, a memory 475 is included in processing logic 470. In other implementations, memory 475 may be external to processing logic 470. In some implementations, memory 475 is located remotely from processing logic 470. In implementations, virtual image(s) are provided to processing logic 470 for presentation in image light 441. In some implementations, virtual images are stored in memory 475. Processing logic 470 may be configured to receive virtual images from a local memory or the virtual images may be wirelessly transmitted to the head mounted device 400 and received by a wireless interface (not illustrated) of the head mounted device.

FIG. 4 illustrates that processing logic 470 is communicatively coupled to cameras 493A and 493B. First camera 493A captures first images 495A and second camera 493B captures second images 495B. Processing logic 470 may select a particular camera to capture images in response to gaze direction data 465 received from eye-tracking system 460.

In some implementations, processing logic 470 may transmit gaze direction data 465 and images 496 to a mobile device 499 or other computing device. Images 496 may include the one or more images 495 received from cameras 493A and 493B. Processing logic 498 of mobile device 499 may then generate the gaze-guided images using any of the techniques of this disclosure. Transmitting the gaze direction data 465 and image 496 to mobile device 499 for generating the gaze-guided images may be advantageous to conserve compute power and processing power of head mounted device 400, for example.

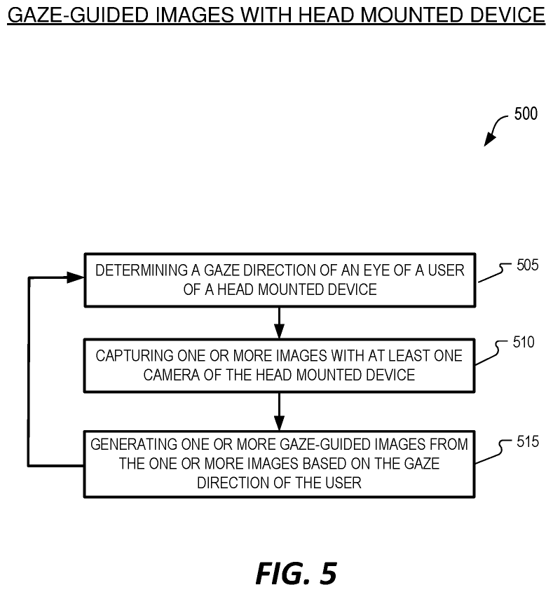

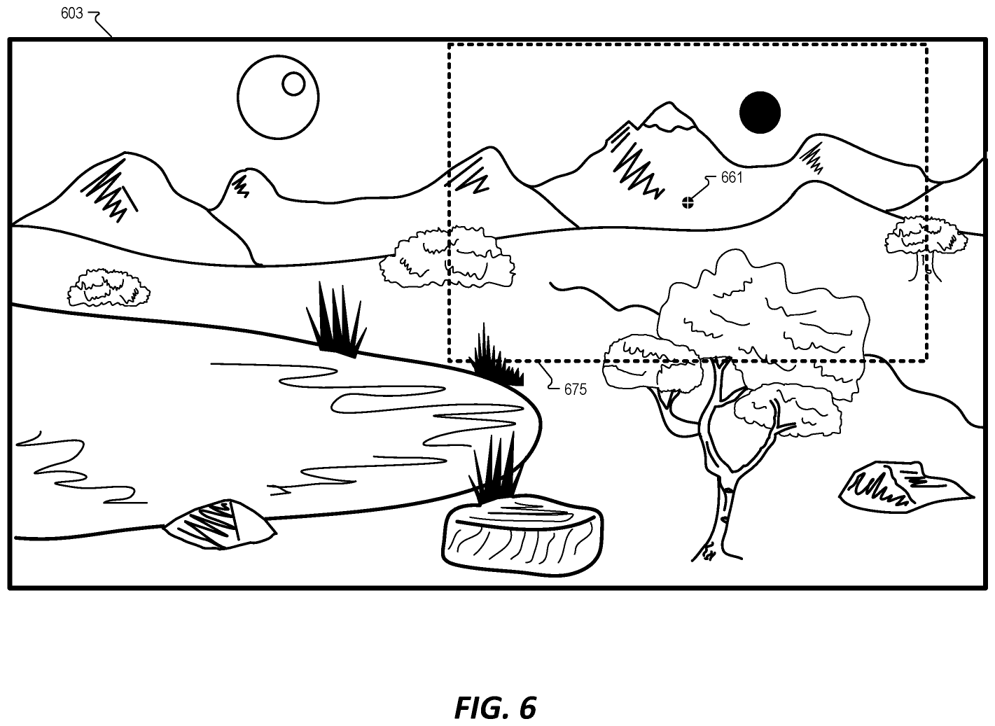

FIG. 5 illustrates a flow chart illustrating an example process 500 of generating gaze-guided images with a head mounted device, in accordance with implementations of the disclosure. The order in which some or all of the process blocks appear in process 500 should not be deemed limiting. Rather, one of ordinary skill in the art having the benefit of the present disclosure will understand that some of the process blocks may be executed in a variety of orders not illustrated, or even in parallel. All or a portion of the process blocks in process 500 may be executed by a head mounted device. In some implementations, a portion of process 500 is executed by a device that is other than head mounted device 500. For example, processing logic (e.g. logic 498) may execute a portion of process 500.

In process block 505, a gaze direction of an eye of a user (of a head mounted device) is determined. The gaze direction may be determined by an eye-tracking system (e.g. eye-tracking system 260 or 460) or by processing logic that receives gaze direction data (e.g. processing logic 270 or 470), for example.

In process block 510, one or more images are captured by at least one camera of the head mounted device.

One or more gaze-guided images is generated in process block 515. The one or more gaze-guided images are based on the gaze direction of the user. Process 500 may return to process block 505 after executing process block 515 to determine a new gaze direction of the eye of user and repeat process 500 to generate gaze-guided images based on a gaze direction of the user.

In an implementation of process 500, the at least one camera of process block 510 is included in a plurality of cameras of the head mounted device and generating the one or more gaze-guided images includes selecting a selected camera among the plurality of cameras of the head mounted device. The selected camera is selected to capture the one or more gaze-guided images based on the gaze direction.

In an implementation of process 500, generating the one or more gaze-guided images includes cropping one or more images to generate the gaze-guided images where the one or more images are cropped in response to the gaze direction with respect to a field of view (FOV) of the at least one camera. FIG. 6 illustrates an example cropped image 675 that may be used as a gaze-guided image, in accordance with implementations of the disclosure. FIG. 6 includes a full image 603 that may be in a FOV of a camera (e.g. camera 493B) of a head mounted device. A gaze direction is determined corresponding with gaze vector 661 of FIG. 6. Image 675 is then digitally cropped from full image 603 based on the gaze direction (gaze vector 661 representative of the determined gaze direction). Cropped image 675 may be cropped around gaze vector 661. In other words, the gaze direction of the user may run through the middle of the cropped image 675. Hence, if the user is looking at the mountains in the upper-right of image 603, the gaze-guided image(s) would be of the mountains rather than including the whole scene of image 603.

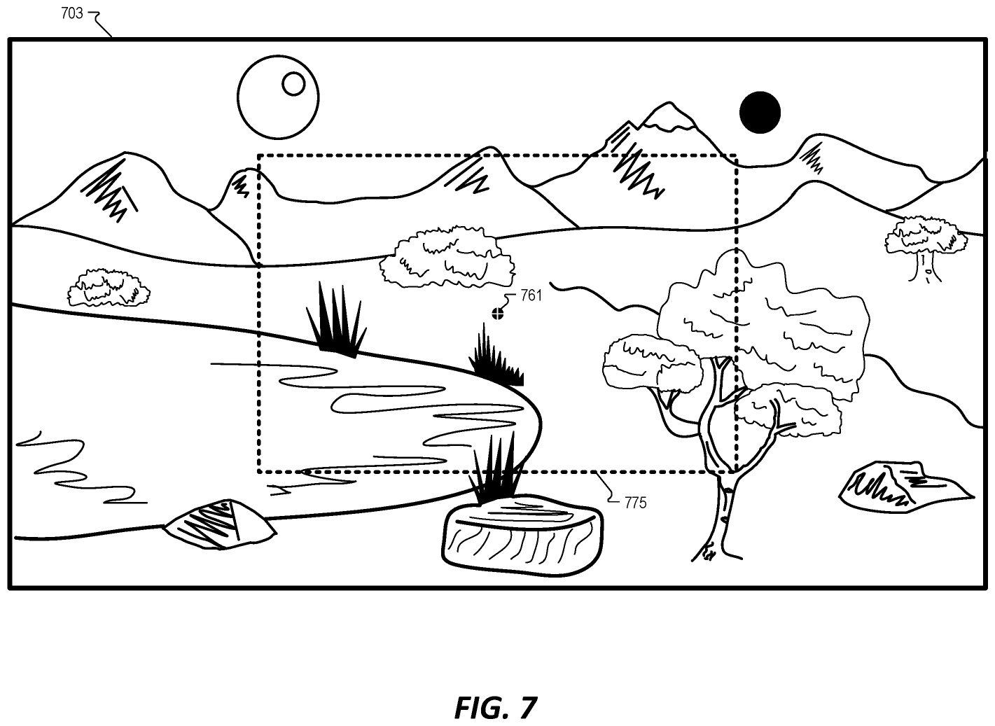

In an implementation of process 500, the at least one camera of process block 510 includes a lens assembly configured to focus image light onto an image sensor of the camera and generating the one or more gaze-guided images includes driving an optical zoom of the lens assembly in response to the gaze direction. FIG. 7 illustrates an example zoomed image 775 that may be used as a gaze-guided image, in accordance with implementations of the disclosure. FIG. 7 includes a full image 703 that may be in a FOV of a camera (e.g. camera 493B) of a head mounted device. A gaze direction is determined corresponding with gaze vector 761 of FIG. 7. An optical zoom feature of the lens assembly of the camera is then zoomed in to capture zoomed image 775 based on the gaze direction (gaze vector 761 representative of the determined gaze direction). The gaze direction of the user may run through the middle of zoomed image 775. In some implementations, the zooming implementations of FIG. 7 is combined with selecting a “selected image sensor” as described in association with FIGS. 2A-2C. In these implementations, a camera or image sensor may be selected based on the gaze direction and then an optical zoom of the lens assembly may be zoomed in to capture a gaze-guided image based on the gaze direction.

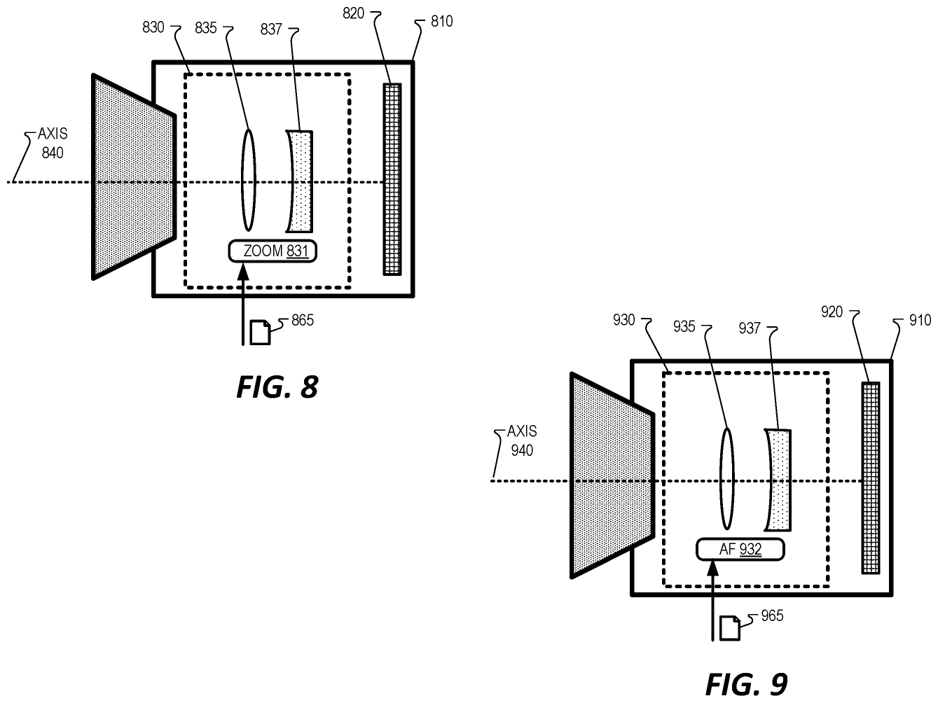

FIG. 8 illustrates an example camera 810 that includes a lens assembly 830 configured to focus image light onto an image sensor 820, in accordance with implementations of the disclosure. Example lens assembly 830 includes a plurality of refractive optical elements 835 and 837. More or fewer optical elements may be included in lens assembly 830. In FIG. 8, optical zoom assembly 831 receives gaze direction data 865 (that includes the gaze direction of the user) and adjusts an optical zoom of camera 810 in response to gaze direction data 865. Adjusting the optical zoom of camera 810 may include moving optical elements of lens assembly 830 along an optical axis 840 of the lens assembly 830. The optical elements may be moved along optical axis 840 with respect to each other or with respect to image sensor 820 to provide zooming functionality, for example. The configuration of camera 810 may be included in any of the cameras described in the disclosure.

Referring again to FIG. 5, in an implementation of process 500, the at least one camera of process block 510 includes a lens assembly configured to focus image light onto an image sensor of the camera and generating the one or more gaze-guided images includes adjusting an auto-focus of the lens assembly in response to the gaze direction. Adjusting the auto-focus of the lens assembly in response to the gaze direction may include identifying a subject in the image that corresponds to the gaze direction and determining an approximate focus distance to the subject in the image. Identifying a subject in an image that corresponds to a gaze direction of the user may utilize gaze calibration data that is recorded during a calibration procedure in an unboxing process of the head mounted device, or otherwise. The subject may be an object, person, animal, or otherwise. The auto-focus of the lens assembly is then adjusted to the focus distance to image the subject. Adjusting the auto-focus may include moving the optical elements within the lens assembly to focus the image at the focus distance and adjusting the aperture of the lens assembly. Adjusting the aperture may create a depth blur effect for an object in an image. In other contexts, a larger depth of field may be warranted.

FIG. 9 illustrates an example camera 910 that includes a lens assembly 930 having an auto-focus module configured to focus image light onto an image sensor 920, in accordance with implementations of the disclosure. Example lens assembly 930 includes a plurality of refractive optical elements 935 and 937. More or fewer optical elements may be included in lens assembly 930. In FIG. 9, auto-focus module 932 receives gaze direction data 965 (that includes the gaze direction of the user) and adjusts an optical focus of camera 910 in response to gaze direction data 965. Adjusting the auto-focus of camera 910 may include moving optical elements of lens assembly 930 along an optical axis 940 of the lens assembly 930. The optical elements may be moved along optical axis 940 with respect to each other or with respect to image sensor 920 to provide auto-focus functionality for example. The configuration of camera 910 may be included in any of the cameras described in the disclosure.

By way of example, a subject such as mountains 241 in FIG. 2C may correspond to a gaze direction or vergence data included in gaze direction data. A focus distance of the mountains 241 may be miles or kilometers away (optical infinity) and the auto-focus module 932 of FIG. 9 may be adjusted to that focus distance (optical infinity) to image the subject mountains 241. Determining an approximate focus distance of the subject may include known auto-focus techniques such as through-the lens autofocusing that includes adjusting the lens assembly until the subject of the image has sufficient contrast, for example. Other techniques of determining a focus distance of a subject may also be used. In some implementations, a depth sensor is included in a head mounted device to map the depth of the scene and the distance of the subject that the user is looking at can be determined by using the depth mapping of the scene and vergence data of the eyes of the user. The depth sensor may include a depth camera, a time of flight (ToF) sensor, and infrared proximity sensor(s), or other suitable depth sensors.

In another implementation of process 500, generating the one or more gaze-guided images includes: (1) identifying a focus distance that corresponds with the gaze direction of the user; and (2) applying filters to the one or more images to generate the gaze-guided images. In an example, a blur filter is applied to the one or more images to blur a foreground of the image (the foreground having a depth less than the focus distance) and/or a background of the image (the background having a depth greater than the focus distance). In this way, the subject that the user may be gazing at is in focus (sharp) in the gaze-generated image.

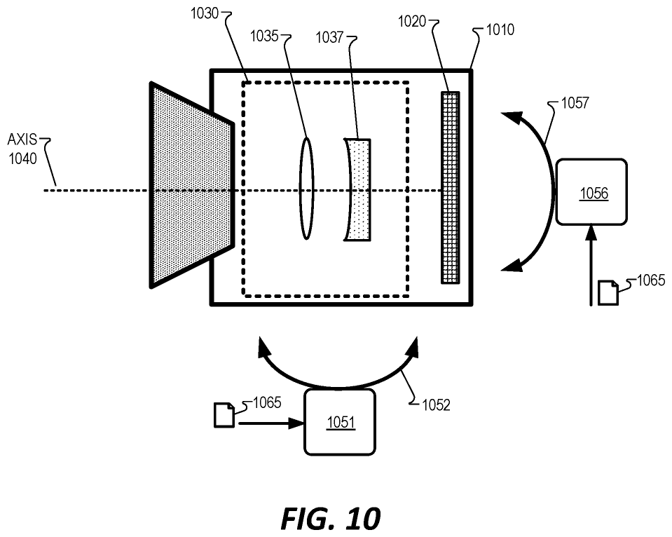

In yet another implementation of process 500, the at least one camera of process block 510 includes a lens assembly configured to focus image light onto an image sensor of the camera and generating the one or more gaze-guided images includes rotating the image sensor and the lens assembly of the camera in response to the gaze direction. In other words, the camera may be physically rotated to be pointed where the user is gazing. FIG. 10 illustrates an example camera 1010 that can be rotated, in accordance with implementations of the disclosure. Camera 1010 includes an image sensor 1020 and an example lens assembly 1030. Example lens assembly 1030 includes a plurality of refractive optical elements 1035 and 1037. More or fewer optical elements may be included in lens assembly 1030. In FIG. 10, rotation module 1051 receives gaze direction data 1065 (that includes the gaze direction of the user) and rotates at least a portion of camera 1010 in response to gaze direction data 1065. Rotation module 1051 adjusts camera 1010 along axis 1052 in response to gaze direction data 1065 so that camera 1010 is pointing where the user is gazing. Rotation module 1051 may be implemented as a micro-electro-mechanical system (MEMS), in some implementations. In some implementations, a second rotation module 1056 receives gaze direction data 1065 (that includes the gaze direction of the user) and rotates at least a portion of camera 1010 in response to gaze direction data 1065. Second rotation module 1056 would rotate camera 1010 along an axis 1057 that is different than axis 1052.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g. 270 and/or 470) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g. 280 and/or 475) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, BlueTooth, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A head mounted device comprising:
an eye-tracking system including one or more sensors configured to determine a gaze direction of an eye in an eyebox region of the head mounted device;
a first image sensor configured to capture first images of an external environment of the head mounted device;
a second image sensor configured to capture second images of the external environment of the head mounted device, wherein the first image sensor has a first field of view (FOV) that is different from a second FOV of the second image sensor; and
processing logic configured to:
receive the gaze direction from the eye-tracking system; and
select a selected image sensor between the first image sensor and the second image sensor to capture one or more gaze-guided images, wherein the first image sensor or the second image sensor is selected to capture the one or more gaze-guided images based on the gaze direction with respect to the first FOV and the second FOV.

2. The head mounted device of claim 1, wherein the selected image sensor is selected based in part on a gaze vector representative of the gaze direction being closest to a middle of a selected FOV of the selected image sensor.

3. The head mounted device of claim 1, wherein the processing logic is further configured to:
receive a subsequent-gaze direction from the eye-tracking system; and
select a subsequent-selected image sensor that is different from the selected image sensor when a subsequent-gaze vector representative of the subsequent-gaze direction becomes closer to a subsequent-selected FOV of the subsequent-selected image sensor that is different from the selected image sensor.

4. The head mounted device of claim 3, wherein the first image sensor is the selected image sensor and the second image sensor is the subsequent-selected image sensor.

5. The head mounted device of claim 1 further comprising:
a memory, wherein the gaze-guided images are saved to the memory as a gaze-guided video file.

6. The head mounted device of claim 1, wherein the first FOV of the first image sensor does not overlap with the second FOV of the second image sensor.

7. The head mounted device of claim 1, wherein the first FOV of the first image sensor overlaps the second FOV of the second image sensor.

8. A head mounted device comprising:
an eye-tracking system including one or more sensors configured to determine a gaze direction of an eye in an eyebox region of the head mounted device;
at least one camera configured to capture images of an external environment of the head mounted device; and
processing logic configured to:
receive the gaze direction from the eye-tracking system; and
generate one or more gaze-guided images from the images based on the gaze direction.

9. The head mounted device of claim 8, wherein generating the one or more gaze-guided images includes:
cropping the one or more images to generate the gaze-guided images, wherein the one or more images are cropped in response to the gaze direction with respect to a field of view (FOV) of the at least one camera.

10. The head mounted device of claim 8, wherein the at least one camera includes a lens assembly configured to focus image light onto an image sensor of the camera, and wherein generating the one or more gaze-guided images includes:
driving an optical zoom of the lens assembly in response to the gaze direction.

11. The head mounted device of claim 8, wherein the at least one camera includes a lens assembly configured to focus image light onto an image sensor of the camera, and wherein generating the one or more gaze-guided images includes:
adjusting an auto-focus of the lens assembly in response to the gaze direction.

12. The head mounted device of claim 11, wherein adjusting the auto-focus of the lens assembly in response to the gaze direction includes:
identifying a subject in the images that corresponds to the gaze direction;
determining an approximate focus distance to the subject in the images; and
adjusting the auto-focus of the lens assembly to the focus distance to image the subject.

13. The head mounted device of claim 8, wherein the at least one camera includes a lens assembly configured to focus image light onto an image sensor of the camera, and wherein generating the one or more gaze-guided images includes:
rotating the image sensor and the lens assembly in response to the gaze direction.

14. A method of operating a head mounted device, the method comprising:
determining a gaze direction of an eye of a user of the head mounted device, wherein an eye-tracking system of the head mounted device determines the gaze direction of the user;
capturing one or more images with at least one camera of the head mounted device, wherein the at least one camera is configured to image an external environment of the head mounted device; and
generating one or more gaze-guided images from the one or more images based on the gaze direction of the user.

15. The method of claim 14, wherein the at least one camera is included in a plurality of cameras of the head mounted device, and wherein generating the one or more gaze-guided images includes:
selecting a selected camera among the plurality of cameras of the head mounted device, wherein the selected camera is selected to capture the one or more gaze-guided images based on the gaze direction.

16. The method of claim 14, wherein generating the one or more gaze-guided images includes:
cropping the one or more images to generate the gaze-guided images, wherein the one or more images are cropped in response to the gaze direction with respect to a field of view (FOV) of the at least one camera.

17. The method of claim 14, wherein generating the one or more gaze-guided images includes:
transmitting the gaze direction from the head mounted device to a mobile device;
transmitting the one or more images from the head mounted device to the mobile device, wherein processing logic of the mobile device generates the gaze-guided images from the one or more images based on the gaze direction of the user.

18. The method of claim 14, wherein the at least one camera includes a lens assembly configured to focus image light onto an image sensor of the camera, and wherein generating the one or more gaze-guided images includes:
adjusting an auto-focus of the lens assembly in response to the gaze direction.

19. The method of claim 18, wherein adjusting the auto-focus of the lens assembly in response to the gaze direction includes:
identifying a subject in the images that corresponds to the gaze direction;
determining an approximate focus distance to the subject in the images; and
adjusting the auto-focus of the lens assembly to the focus distance to image the subject.

20. The method of claim 14, wherein generating the one or more gaze-guided images includes:
identifying a focus distance that corresponds with the gaze direction of the user; and
applying blur effects to the one or more images to blur at least one of a foreground or a background in the one or more images, wherein the background has a background depth that is greater than the focus distance and the foreground has a foreground depth that is less than the focus distance.
